(19) United States
(12) Patent Application Publication
(10) Pub. No.: US 2015/0192460 A1
(43) Pub. Date: Jul. 9, 2015

(54) SENSOR APPARATUS, IN PARTICULAR FOR DETECTING AMBIENT CONDITIONS OF A MOTOR VEHICLE

(71) Applicant: Hella KGaA Hueck & Co., Lippstadt (DE)

(72) Inventors: Alexander Göhmann, Bremen (DE); Dirk Jegminat, Bremen (DE); Henry Kellner, Bremen (DE)

(21) Appl. No.: 14/593,467

(22) Filed: Jan. 9, 2015

(30) Foreign Application Priority Data
Jan. 9, 2014 (DE) 10 2014 000 073.7

(51) Int. Cl. G01J 1/04; G01J 1/42

(52) U.S. Cl. CPC G01J 1/0411; G01J 1/4204

(57) ABSTRACT

In a sensor apparatus, in particular a sensor apparatus for detecting ambient conditions of a motor vehicle, wherein the sensor apparatus comprises at least one screen which predefines the detection angle of the sensor apparatus and a detector and wherein an optical component is disposed between the screen and the detector, a greater detection angle is to be achieved. This is achieved whereby the optical component has at least one first and one second concavely curved region, the first inner region is disposed adjacent to the optic axis, where the second region surrounds the first region and that the first region has a stronger concave curvature than the second region.

The invention relates to a sensor apparatus, in particular a sensor apparatus for detecting ambient conditions of a motor vehicle, wherein the sensor apparatus comprises at least one screen which predefines the detection angle of the sensor apparatus and a detector and wherein an optical component is disposed between the screen and the detector.

Sensor apparatuses of the type mentioned initially are and known and are used, for example, to detect light conditions surrounding the motor vehicle. In EP 0981 470 B1 a combination of rain and external light sensor with a common optical detector is described. The sensor detects the ambient brightness so that lighting systems can be controlled according to the measured ambient brightness. The incident light is guided by a moulded optical waveguide and focussed onto a corresponding photodiode. In this case, the optical waveguide has moulded-in lens structures.

By placing a screen or other optically non-transparent element in front, the detection angle of an optical sensor disposed behind the element is limited. A fixed arrangement of optical elements is subsequently usually difficult to adapt to new requirements since the maximum detection angle is predefined by the screen and the detection angle cannot be enlarged without modifying the arrangement, for example, varying the aperture width of the screen or varying the distance between the screen and the detector.

It is the object of the invention to provide a sensor apparatus in which a larger detection angle than is predefined by the screen is rendered possible without varying the arrangement of the optical elements.

The object is solved with a sensor apparatus according to the features of patent claim 1, with an optical component according to the features of patent claim 7 and a motor vehicle according to the features of patent claim 8. Further developments and advantageous embodiments are given in the respective subclaims.

In a sensor apparatus, in particular a sensor apparatus for detecting ambient conditions of a motor vehicle, wherein the sensor apparatus comprises at least one screen which predefines the detection angle of the sensor apparatus and a detector and wherein an optical component is disposed between the screen and the detector, it is provided as essential to the invention that the optical component has at least one first and one second concavely curved region, that the first inner region is disposed adjacent to the optic axis and at least the second region surrounds the first region and that the first region has a stronger concave curvature than the second region.

The axis of symmetry of the optical component is designated as the optic axis. The optical component has a flat side facing the screen and at least two surfaces having different curvatures. The optical component can be disposed, for example, so that the screen covers the optical component in sections. For example, the dimensions of the various components can be selected so that the maximum coverage is 0.5 mm. Frequently, planoconcave dispersing lenses are used for focussing, the flat side thereof facing the screen. At a planoconcave lens the light fractions incident rather perpendicular to the flat surface from the region of the lens located close to the optic axis are focussed or scattered, whereas the light fraction incident at larger angles rather from regions of the lens located further at the inner edge of the screen, are scattered or focussed. In the optical component having two differently concavely curved regions, the arrangement of the scattering regions is transposed as a result of the different curvatures. The inner concave region is preferably arranged in a circular manner around the optic axis. This region scatters or focuses the light fraction which is incident on the optical component at larger angles. The light fractions incident rather perpendicular to the flat surface of the optical component are scattered or focussed by the outer region of the optical component which surrounds the inner region. In this case, the inner region which is arranged around the optic axis has a stronger concave curvature than the second region surrounding the first region. As a result of this arrangement of the two regions, an enlargement of the detection angle of a detector disposed behind the optical component is achieved. Since the region of the optical component which focuses the fraction of the light which is incident at larger angles on the flat surface is disposed centrally close to the optic axis, light fractions are scattered or focussed at larger angles. The contour of the two optical regions can be described, for example, by a fourth-degree polynomial. Preferably the optical component in the first and in the second region consists throughout of a material such as, for example, glass or a plastic. In an alternative embodiment the first and the second region can also have different optical properties, for example, consist of different material having different refractive indices. For example, the first region can have a larger refractive index than the second region or conversely.

In a preferred embodiment of the sensor apparatus, twice the diameter of the first region is less than or equal to the diameter of the second region. For example, the first region can have a diameter of 1.5 mm and the second region can have a diameter of 4.0 mm. As a result of the given dimensions, an optimal adaptation of the concave regions for scattering or focussing of the incident light on the detector is achieved.

In a preferred embodiment of the invention, the diameter of the second region is less than or equal to four times, in particular less than or equal to three times of the diameter of the first region. As a result of the ratio of the diameter of the first and second region, light fractions incident at larger angles to the flat surface of the lens body can be focussed on the detector.

In a further preferred embodiment of the invention, the optical component has a flat surface and the optical component has a smaller thickness in the first region than in the second region surrounding the inner region. The optical component can be configured as a lens body which has a flat surface. The flat surface of the optical component is preferably facing the screen. The inner region of the optical component which is disposed directly around the optic axis has a stronger concave curvature than the region surrounding it and is configured as a recess in the surface of the lens body facing away from the screen. The region surrounding the inner region is configured as a less strongly defined recess in the lens body. Thus, the thickness of the lens body in the first region is smaller than in the second region.

In a preferred embodiment of the invention it is provided as essential to the invention that the first region and the second region are configured as recesses in a lens body and that the maximum depth of the recess of the first region is at least three times, in particular three times, the maximum depth of the recess of the second region. For the thickness of the lens body a minimum is thus obtained in the first region. For example, the minimum thickness of the lens body in the first region can be 0.8 mm with an overall thickness of the lens body of 2 mm. In this embodiment this results in a maximum depth of the first region of 1.2 mm and a maximum depth of the second region of 0.4 mm. These ratios of the dimensions of the depths of the first and the second region with respect to one another give an optimal focussing of the incident light on the detector.

In a preferred embodiment of the invention, the maximum depth of the recess of the first region is less than five times, in particular less than four times the maximum recess of the second region. The ratio of the depths of the recess of the first and the second region supports the focussing of the incident light on the detector.

In an optical component for a sensor apparatus comprising a screen which predefines the detection angle of the sensor apparatus and a detector, wherein the optical component is disposed between the screen and the detector, it is provided as essential to the invention that the optical component has at least two concavely curved regions, that a first inner region is disposed adjacent to the optic axis and at least one second region surrounds the first region and that the first region has a stronger concave curvature than the second region.

As a result of the arrangement of the optical component with two concavely curved regions between the screen and the detector, an increase in the detection angle of the detector is achieved. Since the inner region has a stronger concave curvature than the second region surrounding it, light fractions which are incident at a larger angle in the flat surface of the optical component are scattered or focussed and guided onto the detector.

A further aspect of the invention relates to a motor vehicle having a sensor apparatus described above.

### BRIEF DESCRIPTION OF THE DRAWINGS

The invention is explained further hereinafter with reference to an exemplary embodiment shown in the drawing. In detail in the schematic diagrams:

FIG. 1 shows a sensor apparatus with a screen, a conventional dispersing lens and a detector; and

FIG. 2 shows a sensor apparatus according to the invention with a screen, a detector and an optical component having two concave surfaces.

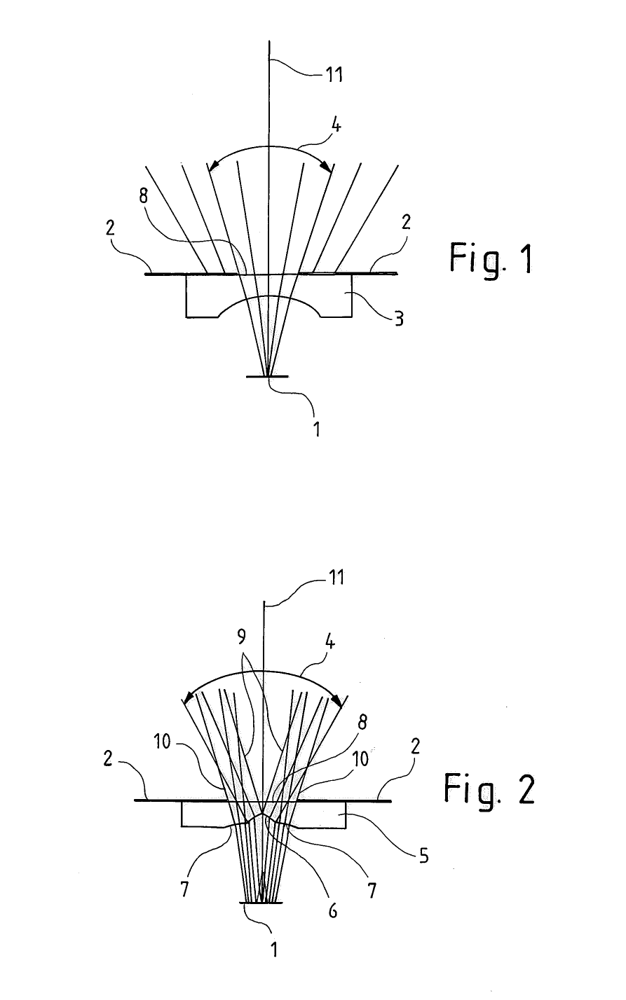

FIG. 1 shows a sensor apparatus comprising a detector 1, a screen 2 and a dispersing lens 3 disposed between the detector and the screen. Incident light is focussed by the dispersing lens 3 and guided onto the detector. The maximum detection angle 4 is predefined by the aperture width of the screen 2. In this arrangement, an increase in the maximum detection angle 4 is only possible by modifying the arrangement, for example, by varying the distance between detector 1 and screen 2 or increasing the aperture width of the screen 2.

FIG. 2 shows a sensor apparatus according to the invention comprising a screen 2, a detector 1 and an optical component 5 disposed between the screen and the detector. The optical component 5 has two regions 6, 7 having different concave curvatures. The first region 6 is disposed around the optic axis 11, the second region 7 is disposed at a greater distance from the optic axis 11 and surrounds the first region 6. The first region 6 has a stronger concave curvature than the second region 7 surrounding it. Light beams incident at larger angles on the flat surface 8 of the optical component 5 are scattered or focussed in the first region 6 near the optic axis 11 whereas light beams 10 incident on the flat surface at steeper angles are scattered or focussed in the second region 7. As a result of the scattering or focussing of the light beams 9 incident at larger angles, an increase in the maximum detection angle 4 is achieved.

All the features mentioned in the preceding description and in the claims can be combined in any selection with the features of the independent claim. The disclosure of the invention is therefore not restricted to the feature combinations described or claimed, on the contrary all appropriate feature combinations within the framework of the invention should be considered to be disclosed.

1. A sensor apparatus for detecting ambient conditions of a motor vehicle, wherein the sensor apparatus comprises at least one screen which predefines the detection angle of the sensor apparatus and a detector and wherein an optical component is disposed between the screen and the detector,
wherein the optical component has at least one first and one second concavely curved region,
the first inner region is disposed adjacent to the optic axis,
the second region surrounds the first region, and
the first region has a stronger concave curvature than the second region.

2. The sensor apparatus according to claim 1, wherein twice the diameter of the first region is less than or equal to the diameter of the second region.

3. The sensor apparatus according to claim 1, wherein the diameter of the second region is less than or equal to four times, in particular less than or equal to three times the diameter of the first region.

4. The sensor apparatus according to claim 1, wherein the optical component has a flat surface and the optical component has a smaller thickness in the first region than in the second region surrounding the inner region.

5. The sensor apparatus according to claim 1, wherein the first region and the second region are configured as recesses in a lens body and that the maximum depth of the recess of the first region is at least four times, in particular three times the maximum depth of the recess of the second region.

6. The sensor apparatus according to claim 5, wherein the maximum depth of the recess of the first region is less than five times, in particular less than four times the maximum recess of the second region.

7. The optical component for a sensor apparatus according to claim 1, comprising a screen which predefines the detection angle of the sensor apparatus and a detector, wherein the optical component is disposed between the screen and the detector,
wherein, the optical component has at least two concavely curved regions,
that a first inner region is disposed adjacent to the optic axis and at least one second region surrounds the first region and
that the first region has a stronger concave curvature than the second region.

8. A motor vehicle having a sensor apparatus according to claim 1.
